(19) United States
(12) Patent Application Publication
(10) Pub. No.: US 2026/0339797 A1
(43) Pub. Date: Oct. 29, 2026

(54) HETEROGENEOUS DISKS UTILIZATION IN FAULT TOLERANT STORAGE SYSTEMS

(71) Applicant: Rakuten Symphony, Inc., Tokyo (JP)

(72) Inventors: Nilesh Sitaram Somani, San Mateo, CA (US); Sree Nandan Atur, San Mateo, CA (US)

(21) Appl. No.: 19/192,699

(22) Filed: Apr. 29, 2025

(51) Int. Cl. G06F 11/20; G06F 11/16

(52) U.S. Cl. CPC G06F 11/2089; G06F 11/1612

(57) ABSTRACT

A system for fault tolerant storage includes a network environment including a plurality of computing devices and a plurality of storage devices. The system includes an orchestrator executing in the network environment and configured to receive a first storage request including a first size requirement and a first redundancy requirement. The orchestrator allocates a first storage capacity according to the first size requirement on a first portion of the plurality of storage devices, a first number of storage devices in the first portion corresponding to the first redundancy requirement. The orchestrator updates a remnant table according to the first storage capacity and the first number, the remnant table including one or more entries, each entry indicating an allocation size and a number of storage devices having unallocated storage capacity at least as large as the allocation size.

### FIELD

The present disclosure relates to utilization of heterogeneous disks in fault tolerant storage systems.

### BACKGROUND

The information disclosed in this background section is only for enhancement of understanding of the general background of the disclosure and should not be taken as an acknowledgement or any form of suggestion that this information forms the prior art already known to a person skilled in the art.

Many data centers and other installations exist over many years and inevitably include servers having a variety of configurations. In particular, the persistent storage devices of servers, e.g., hard disk drives, non-volatile memory, etc., may have different sizes. In addition, the capacity of some devices, e.g., NAND flash storage, degrades over time.

### SUMMARY

In one aspect, a system for fault tolerant storage includes a network environment including a plurality of computing devices and a plurality of storage devices. The system includes an orchestrator executing in the network environment and configured to receive a first storage request including a first size requirement and a first redundancy requirement. The orchestrator allocates a first storage capacity according to the first size requirement on a first portion of the plurality of storage devices, a first number of storage devices in the first portion corresponding to the first redundancy requirement. The orchestrator updates a remnant table according to the first storage capacity and the first number, the remnant table including one or more entries, each entry indicating an allocation size and a number of storage devices having unallocated storage capacity at least as large as the allocation size.

In another aspect, a method for fault tolerant storage includes receiving, by an orchestrator executing in a network environment including a plurality of computing devices and a plurality of storage devices, a first storage request including a first size requirement and a first redundancy requirement. The method includes allocating, by the orchestrator, a first storage capacity according to the first size requirement on a first portion of the plurality of storage devices, a first number of storage devices in the first portion corresponding to the first redundancy requirement. The method includes updating, by the orchestrator, a remnant table according to the first storage capacity and the first number, the remnant table including one or more entries, each entry indicating an allocation size and a number of storage devices having unallocated storage capacity at least as large as the allocation size.

In another aspect, a non-transitory computer-readable medium stores executable code that, when executed by a computing device, causes the computing device to receive, by an orchestrator executing in a network environment including a plurality of computing devices and a plurality of storage devices, a first storage request including a first size requirement and a first redundancy requirement. The orchestrator allocates a first storage capacity according to the first size requirement on a first portion of the plurality of storage devices, a first number of storage devices in the first portion corresponding to the first redundancy requirement. The orchestrator updates a remnant table according to the first storage capacity and the first number, the remnant table including one or more entries, each entry indicating an allocation size and a number of storage devices having unallocated storage capacity at least as large as the allocation size.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 is a schematic block diagram of a network environment in which containers may be deployed in accordance with an embodiment;

FIG. 2 is a schematic block diagram showing components for implementing improved utilization of heterogeneous disks in fault tolerant storage systems in accordance with an embodiment;

FIG. 3A is a process flow diagram of a method for implementing improved utilization of heterogeneous disks in fault tolerant storage systems in accordance with an embodiment;

FIG. 3B is a process flow diagram of a method for implementing improved utilization of heterogeneous disks in fault tolerant storage systems in accordance with an embodiment; and

FIG. 4 is a schematic block diagram of an example computing device suitable for implementing methods in accordance with embodiments of the disclosure

### DETAILED DESCRIPTION

The following detailed description of example embodiments refers to the accompanying drawings. The present disclosure provides illustrations and descriptions, but is not intended to be exhaustive or to limit the implementations to the precise form disclosed. Modifications and variations are possible in light of the present disclosure or may be acquired from practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

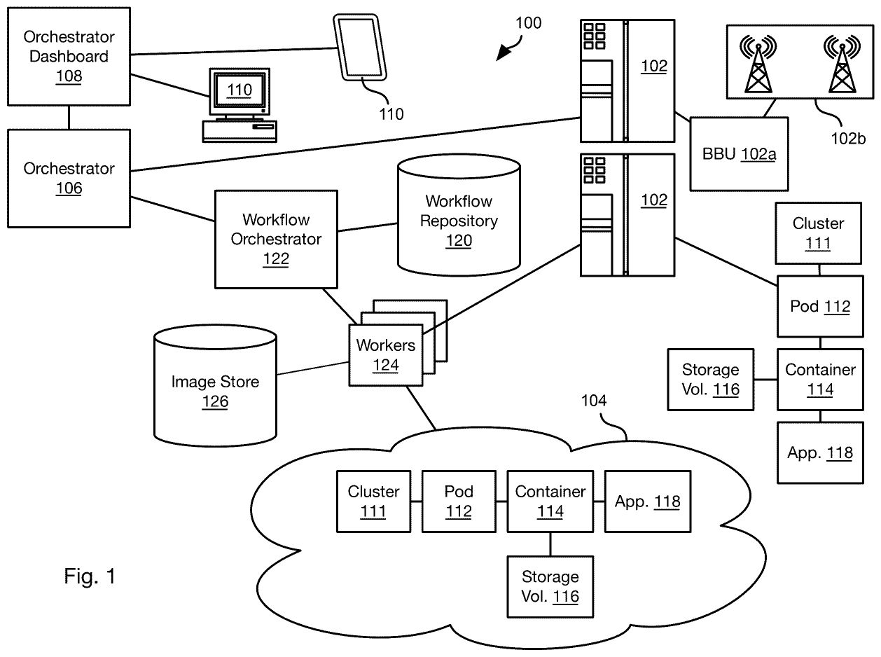

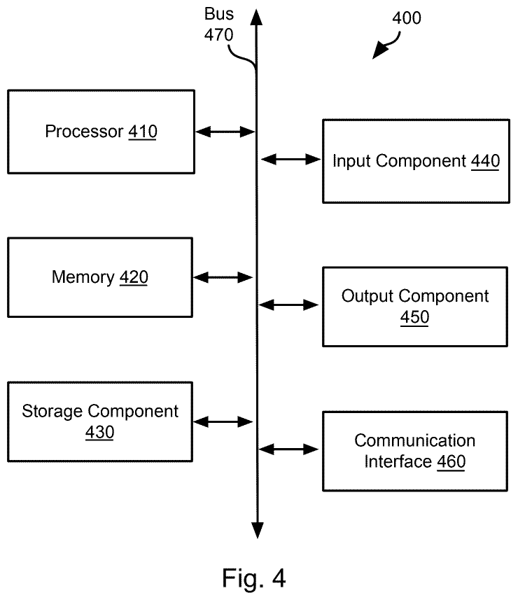

FIG. 1 illustrates an example network environment 100 in which the systems and methods disclosed herein may be used. The components of the network environment 100 may be connected to one another by a network such as a local area network (LAN), wide area network (WAN), the Internet, a backplane of a chassis, or other type of network. The components of the network environment 100 may be connected by wired or wireless network connections. The network environment 100 includes a plurality of servers 102. Each of the servers 102 may include one or more computing devices, such as a computing device having some or all of the attributes of the computing device 400 of FIG. 4.

Computing resources may also be allocated and utilized within a cloud computing platform 104, such as amazon web services (AWS), GOOGLE CLOUD, AZURE, or other cloud computing platform. Cloud computing resources may include purchased physical storage, processor time, memory, and/or networking bandwidth in units designated by the provider by the cloud computing platform. Accordingly, references to a server 102 herein may also refer to a virtualized server implemented by computing nodes of a cloud computing platform 104.

In some embodiments, some or all of the servers 102 may function as edge servers in a telecommunication network. The servers 102 may function as a distributed unit (DU) or central unit (CU) according to the open radio access network (O-RAN) standard. The servers 102 may implement a telecommunications cloud including DUs and CUs. For example, some or all of the servers 102 may be coupled to baseband units (BBU) 102a that provide translation between radio frequency signals output and received by antennas 102b and digital data transmitted and received by the servers 102. For example, each BBU 102a may perform this translation according to a cellular wireless data protocol (e.g., 4G, 5G, etc.). In some embodiments, a BBU 102a may be a gNodeB according to the 5G protocol.

An orchestrator 106 provisions computing resources to application instances 118 of one or more different application executables, such as according to a manifest that defines requirements of computing resources for each application instance. The manifest may define dynamic requirements defining the scaling up or scaling down of a number of application instances 118 and corresponding computing resources in response to usage. The orchestrator 106 may include or cooperate with a utility such as KUBERNETES to perform dynamic scaling up and scaling down the number of application instances 118. In some embodiments, the orchestrator 106 may be or include a service management and orchestration (SMO) platform according to the O-RAN standard.

An orchestrator 106 may execute on a computer system that is distinct from the servers 102 and is connected to the servers 102 by a network that requires the use of a destination address for communication, such as using a networking including ethernet protocol, internet protocol (IP), Fibre Channel, or other protocol, including any higher-level protocols built on the previously-mentioned protocols, such as user datagram protocol (UDP), transport control protocol (TCP), or the Like.

The orchestrator 106 may cooperate with the servers 102 to initialize and configure the servers 102. For example, each server 102 may cooperate with the orchestrator 106 to obtain a gateway address to use for outbound communication and a source address assigned to the server 102 for use in inbound communication. The server 102 may cooperate with the orchestrator 106 to install an operating system on the server 102.

The orchestrator 106 may be accessible by way of an orchestrator dashboard 108. The orchestrator dashboard 108 may be implemented as a web server or other server-side application that is accessible by way of a browser or client application executing on a user computing device 110, such as a desktop computer, laptop computer, mobile phone, tablet computer, or other computing device.

The orchestrator 106 may cooperate with the servers 102 in order to provision computing resources of the servers 102 and instantiate components of a distributed computing system on the servers 102 and/or on the cloud computing platform 104. For example, the orchestrator 106 may ingest a manifest defining the provisioning of computing resources to, and the instantiation of, components such as a cluster 111, pod 112 (e.g., KUBERNETES pod), container 114 (e.g., DOCKER container), storage volume 116, and an application instance 118. The orchestrator 106 may then allocate computing resources and instantiate the components according to the manifest.

The manifest may define requirements such as network latency requirements, affinity requirements (same node, same chassis, same rack, same data center, same cloud region, etc.), anti-affinity requirements (different node, different chassis, different rack, different data center, different cloud region, etc.), as well as minimum provisioning requirements (number of cores, amount of memory, etc.), performance or quality of service (QoS) requirements, or other constraints. The orchestrator 106 may therefore provision computing resources in order to satisfy or approximately satisfy the requirements of the manifest.

The instantiation of components and the management of the components may be implemented by means of workflows. A workflow is a series of tasks, executables, configuration, parameters, and other computing functions that are predefined and stored in a workflow repository 120. A workflow may be defined to instantiate each type of component (cluster 111, pod 112, container 114, storage volume 116, application instance 118, etc.), monitor the performance of each type of component, repair each type of component, upgrade each type of component, replace each type of component, copy (snapshot, backup, etc.) and restore from a copy each type of component, and other tasks. Some or all of the tasks performed by a workflow may be implemented using KUBERNETES or other utility for performing some or all of the tasks.

The orchestrator 106 may instruct a workflow orchestrator 122 to perform a task with respect to a component. In response, the workflow orchestrator 122 retrieves the workflow from the workflow repository 120 corresponding to the task (e.g., the type of task (instantiate, monitor, upgrade, replace, copy, restore, etc.) and the type of component. The workflow orchestrator 122 then selects a worker 124 from a worker pool and instructs the worker 124 to implement the workflow with respect to a server 102 or the cloud computing platform 104. The instruction from the orchestrator 106 may specify a particular server 102, cloud region or cloud provider, or other location for performing the workflow. The worker 124, which may be a container, then implements the functions of the workflow with respect to the location instructed by the orchestrator 106. In some implementations, the worker 124 may also perform the tasks of retrieving a workflow from the workflow repository 120 as instructed by the workflow orchestrator 122. The workflow orchestrator 122 and/or the workers 124 may retrieve executable images for instantiating components from an image store 126.

The servers 102 executing clusters 111 may have variable utilization over time and may therefore have additional clusters 111 instantiated thereon in response to utilization. Using the approach described herein, servers 102 are selected for instantiation of a cluster in order to reduce increases in energy utilization.

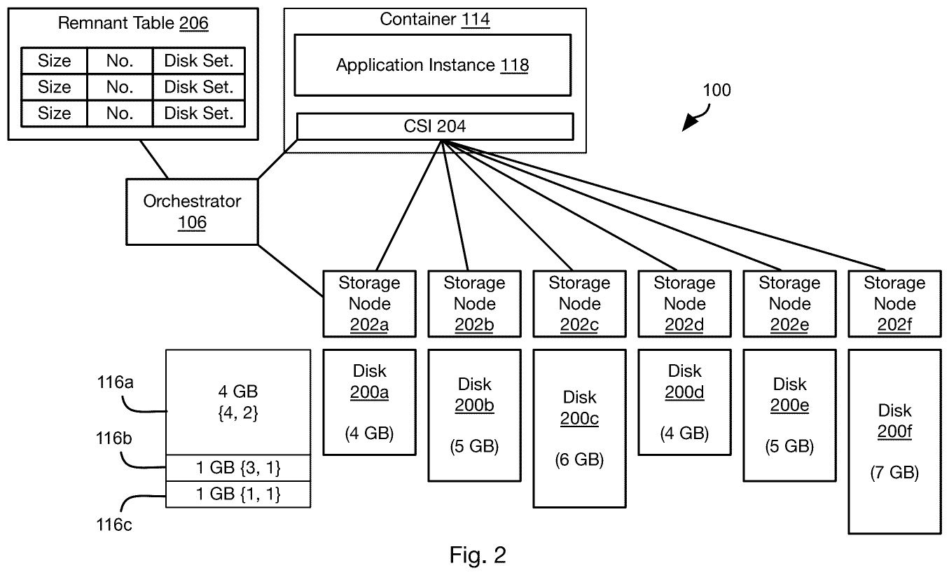

Referring to FIG. 2, a storage volume 116 that is mounted to a container 114 may be a fault tolerant storage volume 116. The storage volume 116 may therefore store data across multiple disks 200a-200f. As used herein “disk” refers to any persistent storage device, such as a hard disk drive, solid state drive, or any other type of rewritable storage device or non-volatile memory device. Original data may be stored using a fault tolerant storage scheme that includes processing original data to obtain N blocks stored in N different disks 200a-200f such that only N−M of the blocks are required to recover the original data, where N and M are integers and N>M. For example, the original data may be processed according to erasure coding, error correction coding, a redundant array of independent disk (RAID) approach, or any other redundant storage scheme.

In many redundant storage schemes, the multiple blocks are the same size and therefore an allocation of a same amount of storage capacity on N different disks 200a-200f is required. The N different disks 200a-200f may be physically mounted to a plurality of different storage nodes 202a-202f. However, in some embodiments, fault tolerance requirements may allow the same storage node 202a-202f to have multiple disks 200a-200f physically mounted thereto.

As shown in FIG. 2, the disks 200a-200f may have different sizes and therefore simply allocating storage capacity of the disks 200a-200f in chunks of equal size will result in unused capacity of the larger disks 200a-200f. For example, a storage volume 116a may require {4, 2} erasure coding: 6 blocks including 4 copies of the data and 2 parity blocks that are tolerant to a loss of any 2 of the 6 blocks. Such a storage volume 116a may be allocated 4 GB on each of disks 200a-200f. Leaving 1 GB unused on storage node 202b, 2 GB unused on storage node 202c, 1 GB unused on storage node 202e, and 3 GB unused on storage node 202f.

Using the approach described herein, remnants of the capacity of the disks 200a-200f may be allocated to storage volumes that require less redundancy. For example, a storage volume 116b with {3, 1} erasure coding and a size of 1 GB may be allocated on disks 200b, 200c, 200e, and 200f. A further storage volume 116c with {1, 1} erasure coding (two blocks tolerant to loss of one block} and a size of 1 GB may be allocated on disks 200c and 200f. Accordingly, only 1 GB of storage on disk 200f remains unused in this example.

In some embodiments, a container 114 may execute a container storage interface (CSI) 204 that cooperates with the orchestrator 106 to allocate storage capacity to a storage volume 116a-116c and mount the storage volume to the container 114. The CSI 204 may therefore request that the orchestrator 106 allocate a fault tolerant storage volume 116a-116c of a particular size and redundancy. Alternatively, the CSI 204 may request that the orchestrator 106 create a storage volume 116 for mounting to the container 114 and the orchestrator 106 may determine attributes of the storage volume 116 (size, redundancy, etc.) according to a manifest processed by the orchestrator 106.

The orchestrator 106 may allocate storage on the disks 200a-20f according to a remnant table 206. For example, the remnant table 206 may record the size, number of disks, and identifiers of the disks 200a-200f in a disk set, the disks 200a-200f in the disk set having available capacity at least as large as the size. The remnant table 206 may include entries for multiple disk sets.

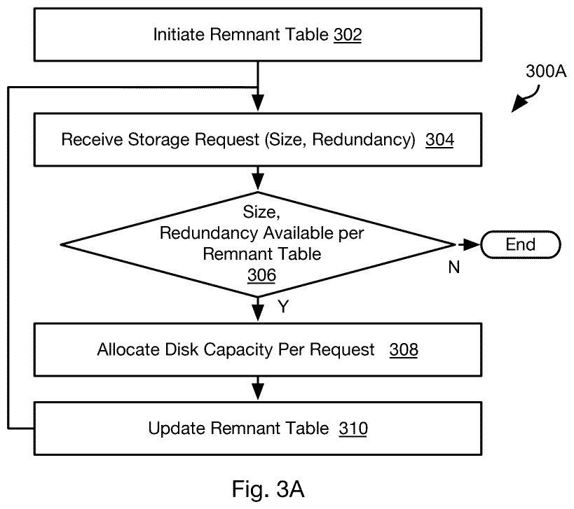

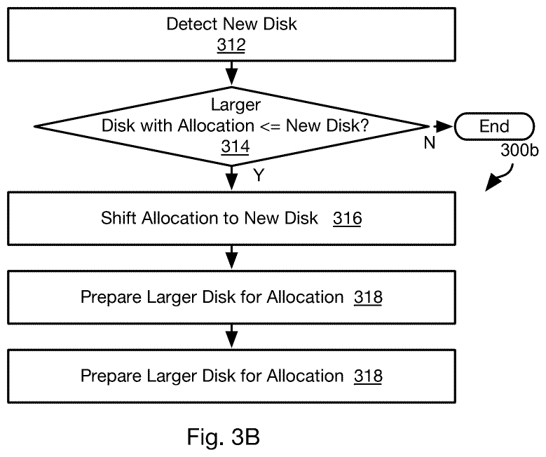

FIG. 3A illustrates a method 300A that may be executed by the orchestrator 106 to allocate capacity of disks 200a-200f of different sizes (i.e., heterogenous disks) to fault tolerant storage volumes 116a-116c using the remnant table 206.

The method 300a may include initiating the remnant table 206 at step 302. For example, suppose X is an integer indicating the maximum permitted number of data blocks in a fault tolerant storage volume. The initial remnant table 206 may include entries for possible disk sets including the size, number of disks, and identifiers of disks in each disk sets, each disk set including no more than X blocks.

The method 300a may include receiving, at step 304, a storage request. The storage request may include a size, e.g., the amount of original data to be stored, and a redundancy, e.g., the number of data blocks used to represent the original data and/or a number of blocks whose loss can be tolerated while still recovering the original data. For example, the redundancy may be a pair of values as used above: {A, B}, where A+B is the total number of data blocks and B is the number of lost blocks that can be tolerated.

The method 300a may include evaluating, at step 306, the request with respect to the remnant table 206. In particular, an entry in the remnant table 206 may be identified, the entry including a size and number of disks that is greater than or equal to the size and redundancy specified in the request. Step 306 may include attempting to identify the entry with the smallest size and smallest number of requests that meets the size and redundancy requirement of the request.

If an entry meeting the size and redundancy requirements of the request is identified at step 306, then the capacity of the set of disks identified in the entry identified at step 306 is allocated at step 308, e.g., storage capacity of each disk equal to the size of the request from step 304 is allocated to the source of the request, e.g., a container 114. Step 310 may include creating a storage volume 116 including the disks of the disk set and which is allocated a portion of each disk in the disk set corresponding to the size of the request.

The method 300a may include updating, at step 310, the remnant table 206 such that the remnant table 206 indicates the size, number of disks, and identifiers of disk available for allocation to a fault tolerant storage volume 116 following the allocation of step 310. Step 310 may include repeating step 302 while accounting for the reduced capacity of disks according to the allocation of step 308.

For example, the size of available capacity of a disk set, number of disks, and/or identifiers of disks may be modified in view of the allocation at step 308. If the allocation completed the allocation of capacity of a disk, the number of disks may be reduced and that disk may be removed from the disk set of the entry. The size of the entry may be reduced by the amount allocated at step 310. If the allocation matches the size and number of disks of an entry, the entry may be removed from the remnant table 206.

Following step 310, the method 300a may continue processing at step 304 when a subsequent storage request is received.

If a disk set with a sufficient number of disks and available capacity is not found at step 306, the method 300a may end. An error message may be returned to the orchestrator 106 and/or operator in order to communicate that the storage request could not be fulfilled.

Referring to FIG. 3B, illustrates a method 300b that may be performed by the orchestrator 106 or other component in the network environment 100. The method 300b may include detecting, at step 312, that a disk has been added (“the new disk”). The new disk may be added to an existing storage node 202a-202f or may be added along with a new storage node.

The method 300b may include evaluating, at step 314, whether another disk, e.g., a previously-added disk 200a-200f, with a capacity larger than the new disk (“the larger disk”) has an allocated portion thereof that is less than or equal to the capacity of the new disk. If not, the method 300 may end with respect to the new disk. If so, the method 300 may include shifting, at step 316, storage allocated to the larger disk to the new disk. Step 316 may therefore include copying data for fault tolerant storage volumes on the larger disk to the new disk. Step 316 may include updating the remnant table to indicate that the capacity of the larger disk is available and to reflect any remaining capacity of the new disk following the allocation of step 316.

The method 300 may include preparing, at step 318, the larger disk for allocation. Step 318 may include decommissioning the larger disk, e.g., sanitizing the larger disk to delete data formerly stored thereon and increase the difficulty of recovering the data. The larger disk is now available to be allocated to another fault tolerant storage volume, such as according to the method 300a.

FIG. 4 illustrates an embodiment of a computing device 400 that may be used to implement any of the computing components described above. As shown in FIG. 4, the device 400 includes processor 410, a memory 420, a storage component 430, an input component 440, an output component 450, a communication interface 460, and a bus 470.

The processor 410, as used herein, means any type of computational circuit that may comprise hardware elements and software elements. The processor 410 may be embodied as a multi-core processor, a single core processor, or a combination of one or more multi-core processors and/or one or more single core processors, a distributed processing system, or the like. The processor 410 may be a Central Processing Unit (CPU), a graphics processing unit (GPU), an accelerated processing unit (APU), an application-specific integrated circuit (ASIC), or another type of processing component.

Memory 420 includes a non-transitory computer readable medium. Memory 420 includes a random-access memory (RAM), a read only memory (ROM), and/or another type of dynamic or static storage device (e.g., a flash memory, a magnetic memory, and/or an optical memory) that stores information and/or instructions for use by processor 410. The memory 420 comprises machine-readable instructions which are executable by the processor 410. These machine-readable instructions when executed by the processor 410 cause the processor 410 to perform one or more method steps of an embodiment described above.

Storage component 430 stores information and/or software related to the operation and use of the device 400. For example, storage component 430 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 440 is configured to receive information, such as user input. For example, the input component 440 may include, but not be limited to, a touch screen display, a keyboard, a keypad, a mouse, a button, a switch, and/or a microphone. Additionally, or alternatively, the input component 440 may include a sensor for sensing information (e.g., a global positioning system (GPS), an accelerometer, a gyroscope, and/or an actuator).

Output component 450 is configured to provide output information from the device 400. For example, the output component 450 may be, but not limited to, a display, a speaker, instructions to an external device, and/or one or more light-emitting diodes (LEDs).

Communication interface 460 is an interface that provides a communication connection to other devices, such as external devices and internal devices. The connection by the communication interface 460 can be a wired connection, a wireless connection, or a combination of wired and wireless connections, and can be a direct connection or an indirect connection via a communication network that exists between the device 400 and other devices. In other words, the standard of the communication interface 460 is not limited.

The bus 470 acts as an interconnect between the processor 410, the memory 420, the storage component 430, the input component 440, the output component 450, and the communication interface 460 of the device 400. The bus 470 may include a wired interconnection or a wireless interconnection.

The number and arrangement of components shown in FIG. 4 are provided as an example. In practice, device 400 may include additional components, fewer components, different components, or differently arranged components than those shown in FIG. 4. Additionally, or alternatively, a set of components (e.g., one or more components) of device 400 may perform one or more functions described as being performed by another set of components of device 400. Further, one or more method steps described in any of the embodiments may be performed utilizing a plurality of devices 400 in communication with one another.

In a first example embodiment, a system for fault tolerant storage includes a network environment including a plurality of computing devices and a plurality of storage devices. The system includes an orchestrator executing in the network environment and configured to receive a first storage request including a first size requirement and a first redundancy requirement. The orchestrator allocates a first storage capacity according to the first size requirement on a first portion of the plurality of storage devices, a first number of storage devices in the first portion corresponding to the first redundancy requirement. The orchestrator updates a remnant table according to the first storage capacity and the first number, the remnant table including one or more entries, each entry indicating an allocation size and a number of storage devices having unallocated storage capacity at least as large as the allocation size.

In a second example embodiment of the first example embodiment, the orchestrator is further configured to: receive a second storage request including a second size requirement and a second redundancy requirement; allocate, using the remnant table, a second storage capacity according to the second size requirement on a second portion of the plurality of storage devices, a second number of storage devices in the second portion corresponding to the second redundancy requirement; and update the remnant table according to the second storage capacity and the second number.

In a third example embodiment of the second example embodiment, the second storage capacity is smaller than the first storage capacity.

In a fourth example embodiment of the third example embodiment, the second number is smaller than the first number.

In a fifth example embodiment of the first example embodiment, the orchestrator is further configured to define a fault tolerant storage volume including the first portion of the plurality of storage devices.

In a sixth example embodiment of the fifth example embodiment, the fault tolerant storage volume implements erasure coding.

In a seventh example embodiment of the sixth example embodiment, the first number is N+M, where N is a number of copies of original data stored in the storage volume and M is a number of parity blocks.

In an eight example embodiment of the first example embodiment, the orchestrator is KUBERNETES.

In a ninth example embodiment of the first example embodiment, the system further includes a container executing in the network environment, the container configured to generate the first storage request.

In a tenth example embodiment of the ninth example embodiment, the container includes a container storage interface configured to generate the first storage request.

In eleventh example embodiment, a method for fault tolerant storage includes: receiving, by an orchestrator executing in a network environment including a plurality of computing devices and a plurality of storage devices, a first storage request including a first size requirement and a first redundancy requirement; allocating, by the orchestrator, a first storage capacity according to the first size requirement on a first portion of the plurality of storage devices, a first number of storage devices in the first portion corresponding to the first redundancy requirement; and updating, by the orchestrator, a remnant table according to the first storage capacity and the first number, the remnant table including one or more entries, each entry indicating an allocation size and a number of storage devices having unallocated storage capacity at least as large as the allocation size.

In a twelfth example embodiment of the eleventh example embodiment, the method includes receiving, by the orchestrator, a second storage request including a second size requirement and a second redundancy requirement; allocating, by the orchestrator, using the remnant table, a second storage capacity according to the second size requirement on a second portion of the plurality of storage devices, a second number of storage devices in the second portion corresponding to the second redundancy requirement; and updating, by the orchestrator, the remnant table according to the second storage capacity and the second number.

In a thirteenth example embodiment of the twelfth example embodiment, the second storage capacity is smaller than the first storage capacity.

In a fourteenth example embodiment of the thirteenth example embodiment, the second number is smaller than the first number.

In a fifteenth example embodiment of the eleventh example embodiment, the orchestrator is further configured to: define a fault tolerant storage volume including the first portion of the plurality of storage devices.

In a sixteenth example embodiment of the fifteenth example embodiment, the fault tolerant storage volume implements erasure coding.

In a seventeenth example embodiment of the sixteenth example embodiment, the first number is N+M, where N is a number of copies of original data stored in the storage volume and M is a number of parity blocks.

In an eighteenth example embodiment of the eleventh example embodiment, the orchestrator is KUBERNETES.

In a nineteenth example embodiment of the eleventh example embodiment, the method includes generating, by a container storage interface of a container executing in the network environment, the first storage request.

In a twentieth example embodiment, a non-transitory computer-readable medium stores executable code that, when executed by a computing device, causes the computing device to: receive, by an orchestrator executing in a network environment including a plurality of computing devices and a plurality of storage devices, a first storage request including a first size requirement and a first redundancy requirement; allocate, by the orchestrator, a first storage capacity according to the first size requirement on a first portion of the plurality of storage devices, a first number of storage devices in the first portion corresponding to the first redundancy requirement; and update, by the orchestrator, a remnant table according to the first storage capacity and the first number, the remnant table including one or more entries, each entry indicating an allocation size and a number of storage devices having unallocated storage capacity at least as large as the allocation size.

1. A system for fault tolerant storage comprising:
a network environment including a plurality of computing devices and a plurality of storage devices; and
an orchestrator executing in the network environment and configured to:
receive a first storage request including a first size requirement and a first redundancy requirement;
allocate a first storage capacity according to the first size requirement on a first portion of the plurality of storage devices, a first number of storage devices in the first portion corresponding to the first redundancy requirement; and
update a remnant table according to the first storage capacity and the first number, the remnant table including one or more entries, each entry indicating an allocation size and a number of storage devices having unallocated storage capacity at least as large as the allocation size.

2. The system of claim 1, wherein the orchestrator is further configured to:
receive a second storage request including a second size requirement and a second redundancy requirement;
allocate, using the remnant table, a second storage capacity according to the second size requirement on a second portion of the plurality of storage devices, a second number of storage devices in the second portion corresponding to the second redundancy requirement; and
update the remnant table according to the second storage capacity and the second number.

3. The system of claim 2, wherein the second storage capacity is smaller than the first storage capacity.

4. The system of claim 3, wherein the second number is smaller than the first number.

5. The system of claim 1, wherein the orchestrator is further configured to:
define a fault tolerant storage volume including the first portion of the plurality of storage devices.

6. The system of claim 5, wherein the fault tolerant storage volume implements erasure coding.

7. The system of claim 6, wherein the first number is N+M, where N is a number of copies of original data stored in the fault tolerant storage volume and M is a number of parity blocks.

8. The system of claim 1, wherein the orchestrator is KUBERNETES.

9. The system of claim 1, further comprising a container executing in the network environment, the container configured to generate the first storage request.

10. The system of claim 9, wherein the container includes a container storage interface configured to generate the first storage request.

11. A method for fault tolerant storage comprising:
receiving, by an orchestrator executing in a network environment including a plurality of computing devices and a plurality of storage devices, a first storage request including a first size requirement and a first redundancy requirement;
allocating, by the orchestrator, a first storage capacity according to the first size requirement on a first portion of the plurality of storage devices, a first number of storage devices in the first portion corresponding to the first redundancy requirement; and
updating, by the orchestrator, a remnant table according to the first storage capacity and the first number, the remnant table including one or more entries, each entry indicating an allocation size and a number of storage devices having unallocated storage capacity at least as large as the allocation size.

12. The method of claim 11, further comprising:
receiving, by the orchestrator, a second storage request including a second size requirement and a second redundancy requirement;
allocating, by the orchestrator, using the remnant table, a second storage capacity according to the second size requirement on a second portion of the plurality of storage devices, a second number of storage devices in the second portion corresponding to the second redundancy requirement; and
updating, by the orchestrator, the remnant table according to the second storage capacity and the second number.

13. The method of claim 12, wherein the second storage capacity is smaller than the first storage capacity.

14. The method of claim 13, wherein the second number is smaller than the first number.

15. The method of claim 11, wherein the orchestrator is further configured to:
define a fault tolerant storage volume including the first portion of the plurality of storage devices.

16. The method of claim 15, wherein the fault tolerant storage volume implements erasure coding.

17. The method of claim 16, wherein the first number is N+M, where N is a number of copies of original data stored in the fault tolerant storage volume and M is a number of parity blocks.

18. The method of claim 11, wherein the orchestrator is KUBERNETES.

19. The method of claim 11, further comprising generating, by a container storage interface of a container executing in the network environment, the first storage request.

20. A non-transitory computer-readable medium storing executable code that, when executed by a computing device, causes the computing device to:
receive, by an orchestrator executing in a network environment including a plurality of computing devices and a plurality of storage devices, a first storage request including a first size requirement and a first redundancy requirement;
allocate, by the orchestrator, a first storage capacity according to the first size requirement on a first portion of the plurality of storage devices, a first number of storage devices in the first portion corresponding to the first redundancy requirement; and
update, by the orchestrator, a remnant table according to the first storage capacity and the first number, the remnant table including one or more entries, each entry indicating an allocation size and a number of storage devices having unallocated storage capacity at least as large as the allocation size.
